(19) United States
(12) Patent Application Publication
(10) Pub. No.: US 2024/0381124 A1
(43) Pub. Date: Nov. 14, 2024

(54) STATEFUL ACCESS POINT LINK DISABLEMENT MECHANISMS FOR IMPROVING NETWORK EFFICIENCY

(71) Applicant: Cisco Technology, Inc., San Jose, CA (US)

(72) Inventors: Indermeet Singh Gandhi, San Jose, CA (US); Malcolm Smith, Richardson, TX (US); Brian Donald Hart, Sunnyvale, CA (US)

(21) Appl. No.: 18/362,264

(22) Filed: Jul. 31, 2023

Related U.S. Application Data
(60) Provisional application No. 63/501,712, filed on May 12, 2023.

(51) Int. Cl. H04W 24/02; H04W 24/08; H04W 40/02; H04W 48/06; H04W 72/52; H04W 76/10

(52) U.S. Cl. CPC H04W 24/02; H04W 24/08; H04W 40/02; H04W 48/06; H04W 72/52; H04W 76/10

(57) ABSTRACT

A system and method for stateful access point link disablement mechanisms for improving network efficiency. In one embodiment, a method includes receiving a management frame that indicates a data transfer from a station, where the management frame comprises information identifying one or more characteristics of the data transfer, selecting a communication link based at least in part on the management frame, and communicating information associated with the communication link to one or more other stations.

### RELATED APPLICATION AND CLAIM TO PRIORITY

This application claims priority to U.S. Provisional Application No. 63/501,712 filed May 12, 2023, and titled “Stateful Access Point Link Disablement Mechanisms for Improving Network Efficiency,” which is incorporated herein by reference.

### TECHNICAL FIELD

The present disclosure relates generally to a field of wireless communication systems and, more particularly, to stateful access point link disablement mechanisms for improving network efficiency.

### BACKGROUND

In wireless communication systems, stations (STAs) utilize one or more communication links to communicate with an access point (AP). In some cases, an AP may dedicate a communication link such that only one STA, or a particular group of STAs, may use the communication link for some period of time. Conventional approaches for establishing and using such dedicated links leads to various inefficiencies.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an example system for stateful access point link disablement mechanisms for improving network efficiency, according to some embodiments of the present disclosure;

FIG. 2 illustrates an example system for stateful access point link disablement mechanisms for improving network efficiency, according to some embodiments of the present disclosure;

FIG. 3 illustrates an example signaling diagram for stateful access point link disablement mechanisms for improving network efficiency, according to some embodiments of the present disclosure;

FIG. 4 illustrates an example method for stateful access point link disablement mechanisms for improving network efficiency; and

FIG. 5 illustrates an example of a computer system, according to some embodiments of the present disclosure.

### DESCRIPTION OF EXAMPLE EMBODIMENTS

### Overview

Embodiments of this disclosure disclose systems and methods for stateful access point link disablement mechanisms for improving network efficiency. Wi-Fi 7 (i.e., the IEEE 802.11be amendment and drafts thereof) seeks to improve deterministic networking with features such as Stream Classification Service (SCS), restricted Target Wake Time (rTWT), and multi-link device (MLD)/multi-link operation (MLO), which can be used to dedicate a particular communication link for critical traffic (e.g., traffic associated with a particular traffic ID (TID) or set of TIDs) (e.g., as it would with 5G slices with, for example, dedicated guaranteed bit rate (GBR) radio access bearer (RAB)). However, giving particular traffic (e.g., traffic associated with a particular TID or TIDs) exclusive rights to a dedicated link (e.g., as done before the 802.11be amendment) may be inefficient, as such a dedicated link may be underutilized when there is no or little such traffic to be exchanged on the link. An improved mechanism is disclosed which creates this dedicated link on an on-demand basis using a newly-defined stateful link disablement mechanism.

In some embodiments, the techniques described herein relate to a method, including: receiving a management frame that indicates a data transfer from a station, where the management frame includes information identifying one or more characteristics of the data transfer; selecting a communication link based at least in part on the management frame; and communicating information associated with the communication link to one or more other stations.

In some embodiments, the techniques described herein relate to a system, including: one or more processors; and one or more computer-readable non-transitory storage media including instructions that, when executed by the one or more processors, cause one or more components of the system to perform operations including: receiving a management frame that indicates a data transfer from a station, where the management frame includes information identifying one or more characteristics of the data transfer; selecting a communication link based at least in part on the management frame; communicating information associated with the communication link to one or more other stations.

In some aspects, the techniques described herein relate to one or more computer-readable non-transitory storage media embodying instructions that, when executed by a processor, cause performance of operations including: receiving a management frame that indicates a data transfer from a station, where the management frame includes information identifying one or more characteristics of the data transfer; selecting a communication link based at least in part on the management frame; communicating information associated with the communication link to one or more other stations.

In some embodiments, the information associated with the communication link indicates one or more other communication links for the one or more other stations to use for communication. In some embodiments, the one or more characteristics includes a volume of traffic associated with the data transfer. In some embodiments, the one or more characteristics include a time requirement for the data transfer.

In some embodiments, communicating information associated with the communication link to one or more other stations further includes using a traffic identification-to-link mapping request. In some embodiments, communicating information associated with the communication link to one or more other stations further includes communicating a duration during which the one or more other stations are disabled from using the communication link.

In some embodiments, selecting a communication link based at least in part on the management frame further includes determining the communication link based at least in part on one or more of a number of stations that use the communication link, network conditions, an existing usage status of the communication link, and a pending usage status of the communication link.

Technical advantages of certain embodiments of this disclosure may include one or more of the following. A technical advantage of one embodiment may include the assignment of dedicated links for high-priority traffic in a dynamic, on-demand manner such that the dedicated links are not wastefully reserved outside the periods of high-priority traffic. Another technical advantage of one embodiment may avoid the need to reconfigure a media access control (MAC) service state upon dedicated link establishment or reestablishment, thereby increasing network efficiency. Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

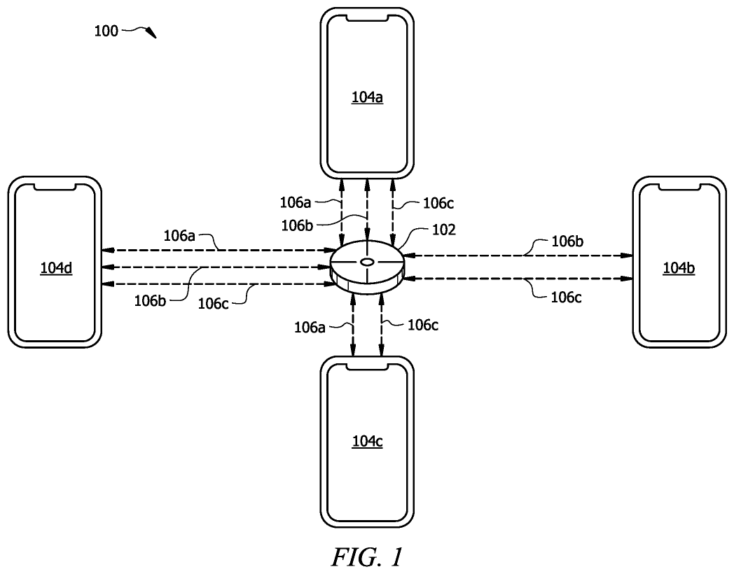

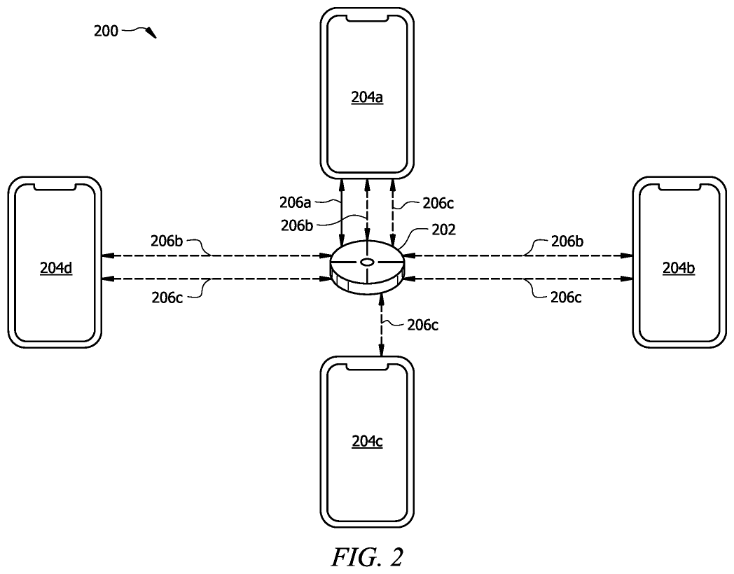

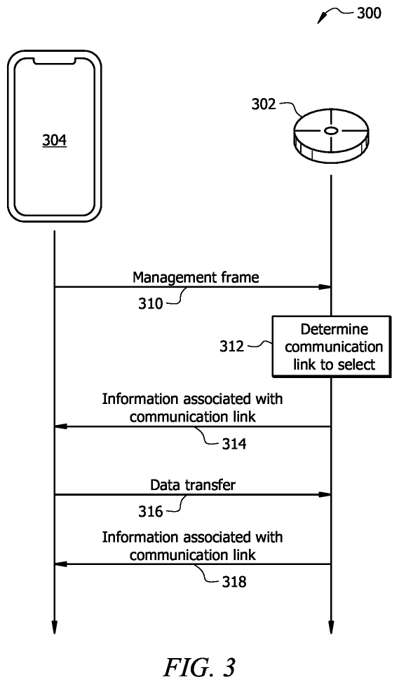

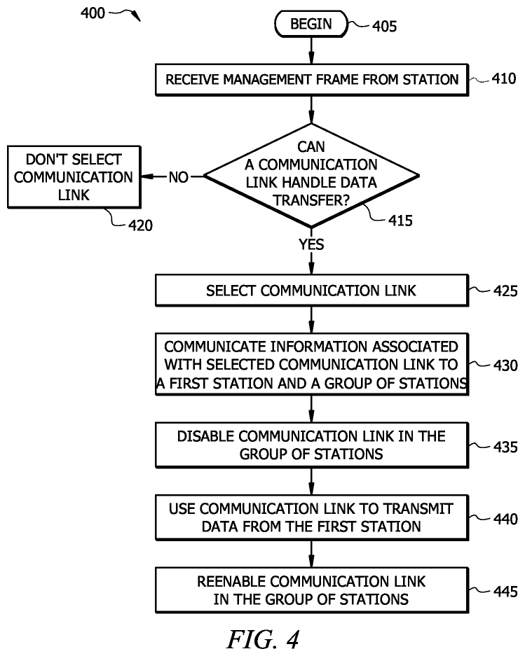

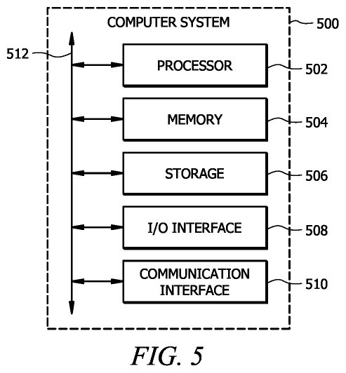

This disclosure describes systems and methods for stateful access point link disablement mechanisms for improving network efficiency. FIG. 1 illustrates an example system for stateful access point link disablement mechanisms for improving network efficiency, in accordance with certain embodiments. FIG. 2 illustrates an example system for stateful access point link disablement mechanisms for improving network efficiency, in accordance with certain embodiments. FIG. 3 illustrates an example signaling diagram for stateful access point link disablement mechanisms for improving network efficiency, in accordance with certain embodiments. FIG. 4 illustrates an example method for stateful access point link disablement mechanisms for improving network efficiency, in accordance with certain embodiments. FIG. 5 illustrates an example of a computer system, in accordance with certain embodiments.

FIG. 1 is an illustration of an example system for stateful access point link disablement mechanisms for improving network efficiency, in accordance with certain embodiments. The components of system 100 may include any suitable combination of hardware, firmware, and software. For example, the components of system 100 may use one or more elements of the computer system of FIG. 5. In the illustrated embodiment, system 100 may include a network implementing at least one of the IEEE 802.11 family of standards (such as that defined by the IEEE 802.11-2016 standard or amendments thereof including, but not limited to, 802.11ah, 802.11ad, 802.11ay, 802.11ax, 802.11az, 802.11ba, and 802.11be). System 100 may include numerous wireless communication devices such as access points (APs) 102 and stations (STAs) 104. While only one AP 102 is shown, system 100 also may include multiple APs 102.

A STA 104 also may be referred to as a mobile station (MS), a mobile device, a mobile handset, a wireless handset, an access terminal (AT), a user equipment (UE), a subscriber station (SS), or a subscriber unit, among other possibilities. A STA 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

AP 102 may represent any device that is capable of managing network resources used for communications between AP 102 and STAs 104. For example, AP 102 may represent any device that is capable of establishing a dedicated or preferred communication link 106 to facilitate communication between a particular STA 104 and AP 102 (e.g., in response to a high-priority data transfer from STA 104, or during a particular time window). Further, AP 102 may be capable of disabling certain communication links 106 for one or more STAs 104 such that the STAs 104 cannot communicate via the disabled communication links 106 (e.g., during a particular time window or until AP 102 re-enables the disabled communication links 106).

A single AP 102 and an associated STA 104 (or set of STAs 104) may be referred to as a basic service set (BSS), which is managed by the respective AP 102. The BSS may be identified to users by a service set identifier (SSID), as well as to other devices by a basic service set identifier (BSSID), which may be a medium access control (MAC) address of the AP 102. AP 102 may periodically broadcast beacon frames (“beacons”) including the BSSID to enable any STAs 104 within wireless range of AP 102 to “associate” or re-associate with AP 102 to establish a respective communication link 106 (hereinafter also referred to as a “Wi-Fi link”), or to maintain a communication link 106, with AP 102. For example, the beacons may include an identification of a primary channel used by AP 102 as well as a timing synchronization function for establishing or maintaining timing synchronization with AP 102. AP 102 may provide access to external networks to various STAs 104 in the WLAN via respective communication links 106.

To establish a communication link 106 with an AP 102, a STA 104 (e.g., STA 104a) may be configured to perform passive or active scanning operations (“scans”) on frequency channels in one or more frequency bands (for example, the 2.4 GHZ, 5.0 GHZ, 6.0 GHZ, or 60 GHz bands). To perform passive scanning, the STA 104 may listen for beacons, which may be transmitted by respective APs 102 at a periodic time interval referred to as the target beacon transmission time (TBTT) (measured in time units (TUs) where one TU may be equal to 1024 microseconds (μs)). To perform active scanning, the STA 104 may generate and sequentially transmit probe requests on each channel to be scanned and then listen for probe responses from one or more APs 102. The STA 104 may be configured to identify or select an AP 102 with which to associate based on the scanning information obtained through the passive or active scans, and to perform authentication and association operations to establish a communication link 106 with the selected AP 102. The AP 102 may assign an association identifier (AID) to the STA 104 at the culmination of the association operations, which the AP 102 may use to track the STA 104.

AP 102 may communicate with STAs 104 (e.g., STA 104a, STA 104b, STA 104c, and STA 104c) via one or more communication links 106 (e.g., 106a, 106b, and 106c), where each communication link 106 may correspond to a different frequency band or a particular frequency channel of a frequency band. For example, communication link 106a may correspond to the 2.4 GHz frequency band, communication link 106b may correspond to the 5.0 GHz frequency band, and communication link 106c may correspond to the 6.0 GHz frequency band. As shown in FIG. 1, STA 104a may communicate with AP 102 via communication links 106a, 106b, and/or 106c; STA 104b may communicate with AP 102 via communication links 106b and/or 106c; STA 104c may communicate with AP 102 via communication links 106a and/or 106c; and STA 104d may communicate with AP 102 via communication links 106a, 106b, and/or 106c.

FIG. 2 is an illustration of an example system for stateful access point link disablement mechanisms for improving network efficiency, in accordance with certain embodiments. The components of system 200 may include any suitable combination of hardware, firmware, and software. For example, the components of system 200 may use one or more elements of the computer system of FIG. 5. AP 202 may correspond to AP 102 described above with reference to FIG. 1. STAs 204 may correspond to STAs 104 as described above with reference to FIG. 1. Communication links 206 may correspond to communication links 106 as described above with reference to FIG. 1.

Through updates to the IEEE 802.11be amendment (including drafts thereof), AP 202 may support two modes of AP link start and stop operation. One mode may be referred to as “stateless,” indicating that a STA 204 and an associated AP 202 may erase Media Access Control (MAC) service state information when the STA 204 disassociates from a particular communication link 206 or AP 202. The stateless mode may be associated with, understood to be, or implement Multi-link Reconfiguration, wherein an AP 202 and/or a STA 204 undergoes one or more procedures to remove information about an AP 202 to which the STA 204 was associated (e.g., AP Removal operations or procedures) and, after reassociating with an AP 202 or particular communication link 206, undergoes one or more procedures to add (or relearn) information about an AP 202 to which the STA 204 associates (e.g., AP Add operations or procedures). A second mode may be referred to as “stateful,” indicating that a STA 204 and an associated AP 202 may preserve a MAC service state associated with the AP 202 or communication link 206 (e.g., when the AP disables a link or STA 204 selects between communication links 206 to transmit or receive traffic). The stateful mode may be associated with, understood to be, or implement Advertised Traffic-ID (TID)-to-Link Mapping (T2LM) features, which may constitute both removing and re-adding information associated with an AP 202.

In certain embodiments, STAs 204 and AP 202 may use the stateful mode to establish dedicated or preferred communication links for transmitting data traffic from STAs 204 to AP 202. For example, when STA 204a has data traffic to be exchanged (e.g., prioritized data traffic, such as a large amount of data that arrives in an intermittent burst), STA 204a may communicate to AP 202 information about the data traffic (e.g., traffic volume, time window associated with the traffic, performance requirements of the traffic) using existing mechanisms such as a Stream Classification Service (SCS) management frame (e.g., as defined by relevant 802.11 amendments) or some other mechanism. In some cases, AP 202 may autonomously monitor data transfers from STA 204a and identify STA 204a's traffic needs.

Upon determining STA 204a's traffic needs, AP 202 may determine a communication link 206 that is able to fulfill the determined traffic needs. For example, AP 202 may determine (e.g., via a management frame from STA 204a or from AP 202's monitoring of STA 204a's data transfers) one or more characteristics and/or requirements associated with an upcoming data transfer from STA 204a. Based on that information, AP 202 may determine which communication link 206 is capable of fulfilling the upcoming data transfer. For example, AP 202 may determine that communication link 206a is capable of fulfilling the upcoming data transfer from STA 204a. Accordingly, AP 202 may select communication link 206a as a dedicated or preferred communication link for the upcoming data transfer from STA 204a.

Upon selecting communication link 206a as the dedicated or preferred communication link, AP 202 may use a stateful link start/stop mechanism to communicate with STAs 204 that the selected communication link (i.e., communication link 206a) is designated for exclusive use by STA 204a. For example, AP 202 may transmit information associated with communication link 206a to STAs 204 (e.g., STA 204a, STA 204b, STA 204c, and STA 204d). The information associated with communication link 206a may identify communication link 206a. Upon receiving the information associated with communication link 206a, STA 204a may determine that communication link 206a has been selected as a dedicated or preferred communication link for STA 204a's upcoming data transfer.

Upon receiving the information associated with communication link 206a, STAs 204b, 204c, and 204d may determine that communication link 206a is disabled for their use. Accordingly, STAs 204b, 204c, and 204d may determine to stop using communication link 206a if they were associated with or otherwise had access to communication link 206a. For example, STAs 204c and 204d may determine to disable communications via communication link 206a upon receiving the information associated with communication link 206a from AP 202. STA 204b may not be associated with or otherwise may not use communication link 206a, so STA 204b may determine that it will not establish a connection with or otherwise use communication link 206a.

In some embodiments, the information associated with communication link 206a may indicate one or more other communication links 206 (e.g., communication link 206b) that STAs 204b, 204c, and 204d may use for communications. In some cases, AP 202 may transmit a T2LM request to STAs 204b, 204c, and 204d that requests STAs 204b, 204c, and 204d move their existing traffic from communication link 206a to one or more other communication links 206 (e.g., communication link 206b or communication link 206c). In certain embodiments, the T2LM request may give STAs 204b, 204c, and 204d a five- to ten-second advanced warning of an upcoming communication link mapping change (e.g., as a result of communication link 206a being exclusively designated for STA 204a). The magnitude of this advance warning may be affected by certain techniques as defined, for example, by relevant communication standards, agreements, etc.

Because STA 204a may have exclusive or near-exclusive use of communication link 206a to transmit its upcoming data transfer, communication link 206a may effectively operate as a “freeway” communication link for STA 204a to exchange data (e.g., prioritized data) with AP 202.

FIG. 3 is an illustration of a signaling diagram 300 for stateful access point link disablement mechanisms for improving network efficiency, according to particular embodiments.

The components shown in FIG. 3 may include any suitable combination of hardware, firmware, and software. For example, the components shown in FIG. 3 may use one or more elements of the computer system of FIG. 5. AP 302 and STA 304 may be associated with each other and may exchange one or more messages as shown in FIG. 3. AP 302 may correspond to AP 102 described above with reference to FIG. 1 and to AP 202 described above with reference to FIG. 2. STA 304 may correspond to STA 104a as described above with reference to FIG. 1 and STA 204a as described above with reference to FIG. 2.

As discussed above with reference to FIG. 2, STA 304 may transmit a management frame 310 to AP 302. Management frame 310 may include information that characterizes an upcoming data transfer from STA 304. For example, management frame 310 may include information that describes a volume of traffic associated with the upcoming data transfer. Management frame 310 may further include information that describes a time requirement associated with the upcoming data transfer. For example, the upcoming data transfer may be a time-sensitive transfer that must be transmitted in a particular time window; management frame 310 may include information that indicates the particular time window (e.g., via start and stop times or a time duration). Management frame 310 may include information that indicates a bit rate or other metric that reflects a traffic volume per unit of time (e.g., bits per second) associated with the upcoming data transfer. Management frame 310 may be included in a SCS request, for example. STA 304 may transmit management frame 310 in a periodic manner, or STA 304 may transmit management frame 310 when STA 304 has an upcoming priority data traffic transmission (e.g., a time-sensitive burst of data traffic).

Upon receiving the management frame 310, AP 302, at step 312, may determine and select a communication link over which the upcoming data transfer may be transmitted. For example, AP 302 may select the communication link based on the information included in management frame 310. For example, AP 302 may determine that a first communication link is better suited to handle the upcoming data transfer than a second communication link based on the characteristics of the first communication link (e.g., utilized frequency band or resources available to the first communication link) and the characteristics of the upcoming data transfer as indicated in management frame 310. Accordingly, AP 302 may determine to select the first communication link. The selection may not be exclusive: for instance the selected link may provide best anticipated service, but the AP and client are not precluded from trying to send some of the data on other links if the selected link is temporarily busy.

In some cases, AP 302 may select the communication link based on a number of stations that use the communication link. For example, AP 302 may determine that a first communication link is currently used by two STAs and a second communication link is currently used by four STAs. Accordingly, AP 302 may determine that the first communication link is less congested than the second communication link, and may therefore determine to select the first communication link.

In some cases, AP 302 may select the communication link based on network conditions experienced by one or more communication links. For example, AP 302 may determine that communications over a first communication link experience greater delay, loss, or jitter than communications over a second communication link. Accordingly, AP 302 may determine that the second communication link is associated with better network conditions than the first communication link, and may therefore determine to select the second communication link.

In some cases, AP 302 may select the communication link based on an existing usage status of one or more communication links. For example, AP 302 may determine that a first communication link is currently being used at 90% capacity (e.g., as indicated by available bandwidth or other resources associated with the communication link), while a second communication link is currently being used at 50% capacity. Accordingly, AP 302 may determine that the second communication link is less congested than the first communication link, and may therefore determine to select the second communication link.

In some cases, AP 302 may select the communication link based on a pending usage status of one or more communication links. For example, AP 302 may determine that a first communication link is scheduled to be at 90% capacity during a time window needed for the upcoming data transfer from STA 304, while a second communication link is scheduled to be at 50% capacity during that time window. Accordingly, AP 302 may determine that the second communication link will be less congested than the first communication link during the time period in which the upcoming data transfer will be transmitted, and may therefore determine to select the second communication link.

Upon selecting a communication link, AP 302 may, in message 314, transmit information associated with the selected communication link to STA 304, as discussed above with reference to FIG. 2. Upon receiving the associated information, STA 304, at step 316, may determine that the selected communication link has been designated for STA 304's exclusive use, and STA 304 may use the selected communication link to transmit the data transfer.

At step 318, AP 302 may determine that the data transfer from STA 304 is complete, and may transmit a second message to STA 304 indicating information associated with the selected communication link. Accordingly, STA 304 may determine that the selected communication link is no longer designated for STA 304's exclusive use, and STA 304 may revert to using one or more other communication links to transmit data transfers.

FIG. 4 illustrates an example method for stateful access point link disablement mechanisms for improving network efficiency, according to some embodiments of the present disclosure. Method 400 begins at step 405. At step 410, AP 102 may receive, from STA 104a, a management frame that contains information associated with an upcoming data transfer from STA 104a. At step 415, AP 102 may determine whether a communication link can handle the upcoming data transfer, as discussed in more detail above with reference to FIG. 3. If AP 102 determines that a communication link cannot handle the upcoming data transfer, then, at step 420, AP 102 does not select the communication link. If AP 102 determines that a communication link can handle the upcoming data transfer, then, at step 425, AP 102 selects the communication link. For example, AP 102 may select communication link 106a for STA 104a's use in transmitting the upcoming data transfer.

At step 430, AP 102 may communicate information associated with communication link 106a (e.g., an identity of communication link 106a) to one or more STAs 104, as discussed in more detail above with reference to FIGS. 2 and 3. Further, AP 102 may communicate to the one or more STAs 104 information that indicates a period of time during which the selected communication link is designated for exclusive use by STA 104a. In some cases, AP 102 may determine the period of time based on information received in the action report, such as information that indicates the volume of traffic associated with the upcoming data transfer from STA 104a, information that indicates a particular time window during which the upcoming data transfer must be transmitted, or information that indicates a bit rate or other metric that reflects a traffic volume per unit of time (e.g., bits per second) associated with the upcoming data transfer (e.g., as discussed in more detail above with reference to FIG. 3).

At step 435, STAs 104b, 104c, and 104d may receive the information associated with the communication link 106a and determine to disable communications on communication link 106a, as discussed in more detail above with reference to FIG. 2. For example, the information associated with communication link 106a may indicate one or more other communication links 106 (e.g., communication link 106b) that STAs 104b, 104c, and 104d may use for communications. In some embodiments, STAs 104b, 104c, and 104d may receive a T2LM request that requests STAs 104b, 104c, and 104d to move their existing traffic (if any) from communication link 106a to one or more other communication links 106, as discussed in more detail above with reference to FIG. 2. Accordingly, STAs 104c and 104d may determine move their existing traffic from communication link 106a to communication link 106c. Because STA 104b may not use communication link 106a, STA 104b may determine to use only communication link 106b for its communications with AP 102 and to avoid establishing a connection with communication link 106a.

At step 440, STA 104a may use communication link 106a to transmit the upcoming data transfer to AP 102, as discussed above in more detail with reference to FIG. 2.

At step 445, AP 102 may reenable communication link 106a for use by STAs 104b, 104c, and 104d. For example, when AP 102 determines that the data transfer from STA 104a is complete, AP 102 may determine to reenable communication link 106a for use by STAs 104b, 104c, and 104d. Accordingly, AP 102 may transmit a message to STAs 104b, 104c, and 104d that includes information associated with communication link 106a (e.g., an identity of communication link 106a), thereby indicating to STAs 104b, 104c, and 104d that communication link 106a is no longer designated for STA 104a's exclusive use.

In some cases, STAs 104b, 104c, and 104d may reenable communication link 106a for their use without additional instruction from AP 102. For example, STAs 104b, 104c, and 104d may have received information from AP 102 that indicates a period of time during which communication link 106a is designated for exclusive use by STA 104a, as discussed above with reference to step 430. Accordingly, STAs 104b, 104c, and 104d may determine to reenable communication link 106a when the indicated period of time lapses.

Although this disclosure describes and illustrates particular steps of method 400 of FIG. 4 as occurring in a particular order, this disclosure contemplates any suitable steps of method 400 of FIG. 4 occurring in any suitable order. Although this disclosure describes and illustrates an example method for stateful access point link disablement mechanisms for improving network efficiency, including the particular steps of method 400 of FIG. 4, this disclosure contemplates any suitable method for stateful access point link disablement mechanisms for improving network efficiency, including any suitable steps, which may include all, some, or none of the steps of method 400 of FIG. 4, where appropriate. Although FIG. 4 describes and illustrates particular components, devices, or systems carrying out particular actions, this disclosure contemplates any suitable combination of any suitable components, devices, or systems carrying out any suitable actions.

FIG. 5 illustrates an example of a computer system, in accordance with certain embodiments. In particular embodiments, one or more computer systems 500 provide functionality described or illustrated herein. As an example, one or more computer systems 500 may be used to provide at least a portion of AP 102 or STAs 104 described with respect to FIG. 1. As yet another example, one or more computer systems 500 may be used to perform one or more steps described with respect to FIG. 3 and FIG. 4. In particular embodiments, software running on one or more computer systems 500 provides functionality described or illustrated herein or performs one or more steps of one or more methods described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a Wi-Fi network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein.

Modifications, additions, or omissions may be made to the elements shown in the figure above. The components of a device may be integrated or separated. Moreover, the functionality of a device may be performed by more, fewer, or other components. The components within a device may be communicatively coupled in any suitable manner. Functionality described herein may be performed by one device or distributed across multiple devices. In general, systems and/or components described in this disclosure as performing certain functionality may comprise non-transitory computer readable memory storing instructions and processing circuitry operable to execute the instructions to cause the system/component to perform the described functionality.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry configured to execute program code stored in memory. The term unit may have conventional meaning in the field of electronics, electrical devices and/or electronic devices and may include, for example, electrical and/or electronic circuitry, devices, modules, processors, receivers, transmitters, memories, logic solid state and/or discrete devices, computer programs or instructions for carrying out respective tasks, procedures, computations, outputs, and/or displaying functions, and so on, as such as those that are described herein.

What is claimed is:

1. A method, comprising:
receiving a management frame that indicates a data transfer from a station, wherein the management frame comprises information identifying one or more characteristics of the data transfer;
selecting a communication link based at least in part on the management frame; and
communicating information associated with the communication link to one or more other stations.

2. The method of claim 1, wherein the information associated with the communication link indicates one or more other communication links for the one or more other stations to use for communication.

3. The method of claim 1, wherein the one or more characteristics includes a volume of traffic associated with the data transfer.

4. The method of claim 1, wherein the one or more characteristics includes a time requirement for the data transfer.

5. The method of claim 1, wherein communicating information associated with the communication link to one or more other stations further comprises using a traffic identification-to-link mapping request.

6. The method of claim 1, wherein communicating information associated with the communication link to one or more other stations further comprises communicating a duration during which the one or more other stations are disabled from using the communication link.

7. The method of claim 1, wherein selecting a communication link based at least in part on the management frame further comprises determining the communication link based at least in part on one or more of a number of stations that use the communication link, network conditions, an existing usage status of the communication link, and a pending usage status of the communication link.

8. A system, comprising:
one or more processors; and
one or more computer-readable non-transitory storage media comprising instructions that, when executed by the one or more processors, cause one or more components of the system to perform operations comprising:
receiving a management frame that indicates a data transfer from a station, wherein the management frame comprises information identifying one or more characteristics of the data transfer;
selecting a communication link based at least in part on the management frame; and
communicating information associated with the communication link to one or more other stations.

9. The system of claim 8, wherein the information associated with the communication link indicates one or more other communication links for the one or more other stations to use for communication.

10. The system of claim 8, wherein the one or more characteristics includes a volume of traffic associated with the data transfer.

11. The system of claim 8, wherein the one or more characteristics includes a time requirement for the data transfer.

12. The system of claim 8, wherein communicating information associated with the communication link to one or more other stations further comprises using a traffic identification-to-link mapping request.

13. The system of claim 8, wherein communicating information associated with the communication link to one or more other stations further comprises communicating a duration during which the one or more other stations are disabled from using the communication link.

14. The system of claim 8, wherein selecting a communication link based at least in part on the management frame further comprises determining the communication link based at least in part on one or more of a number of stations that use the communication link, network conditions, an existing usage status of the communication link, and a pending usage status of the communication link.

15. One or more computer-readable non-transitory storage media embodying instructions that, when executed by a processor, cause performance of operations comprising:
receiving a management frame that indicates a data transfer from a station, wherein the management frame comprises information identifying one or more characteristics of the data transfer;
selecting a communication link based at least in part on the management frame; and
communicating information associated with the communication link to one or more other stations.

16. The one or more computer-readable non-transitory storage media of claim 15, wherein the information associated with the communication link indicates one or more other communication links for the one or more other stations to use for communication.

17. The one or more computer-readable non-transitory storage media of claim 15, wherein the one or more characteristics includes a volume of traffic associated with the data transfer.

18. The one or more computer-readable non-transitory storage media of claim 15, wherein the one or more characteristics includes a time requirement for the data transfer.

19. The one or more computer-readable non-transitory storage media of claim 15, wherein communicating information associated with the communication link to one or more other stations further comprises using a traffic identification-to-link mapping request.

20. The one or more computer-readable non-transitory storage media of claim 15, wherein communicating information associated with the communication link to one or more other stations further comprises communicating a duration during which the one or more other stations are disabled from using the communication link.
